(19) United States
(12) Patent Application Publication
(10) Pub. No.: US 2020/0111174 A1
(43) Pub. Date: Apr. 9, 2020

(54) Probabilistic Load Forecasting via Point Forecast Feature Integration

(71) Applicants: Yishen Wang, San Jose, CA (US); Qicheng Chang, San Jose, CA (US); Xiaoying Zhao, San Jose, CA (US); Di Shi, San Jose, CA (US); Zhiwei Wang, San Jose, CA (US)

(72) Inventors: Yishen Wang, San Jose, CA (US); Qicheng Chang, San Jose, CA (US); Xiaoying Zhao, San Jose, CA (US); Di Shi, San Jose, CA (US); Zhiwei Wang, San Jose, CA (US)

(21) Appl. No.: 16/391,992

(22) Filed: Apr. 23, 2019

Related U.S. Application Data
(60) Provisional application No. 62/741,408, filed on Oct. 4, 2018.

(51) Int. Cl. G06Q 50/06; G06N 3/04; G06N 7/00; G06N 20/00; G06F 17/16

(52) U.S. Cl. CPC G06Q 50/06; G06N 3/0472; G06F 17/16; G06N 20/00; G06N 7/00

(57) ABSTRACT

System and methods are disclosed to forecast electrical loads in an energy grid with a processor to receive load information from the energy grid; and a two-stage probabilistic load forecasting unit with integrated point forecast as a probabilistic load forecasting (PLF), including: a first stage where predetermined features are utilized to train a point forecast model and obtain the feature importance; and a second stage where the forecasting model is trained, taking into consideration point forecast features.

### BACKGROUND

The present invention relates to electrical load forecasting.

Short-term load forecasting (STLF) aims to provide accurate future load setpoints for economic and reliable system operations. STLF has been a standard application for most practical energy management (EMS) applications and an active research area for decades. Traditionally, STLF is mainly conducted with point forecasting, which outputs a deterministic estimation to represent the expected load for the targeted time. Time series analysis, expert systems, artificial neural networks and multiple linear regression have been used in the past.

Recent advancements in the field of artificial intelligence have resulted in new machine learning applications for energy forecasting. The Global Energy Forecasting Competition 2012 (GEFCOM2012) was devoted to state-of-the-art point forecasting techniques for wind and load, as well making available to the public benchmark datasets that would be of specific interest to industry practitioners and academic researchers. In this competition, a number of techniques, including data cleansing, hierarchical forecasting, special days forecasting, temperature forecasting, ensemble forecasting, and integration approaches were all presented to demonstrate the range of forecasting capabilities. Gradient boosting machines, semi-parametric models, multiple linear regression, neural networks, random forests, and additive models were considered to be all winning techniques for the load forecasting track. In addition, weather station selection and recency effect were also shown to effectively improve forecasting performances.

Conventional STLF pose some challenges today for independent system operators (ISOs) and utilities because of new operating environments and technologies, including increased penetration of behind-the-meter distributed energy resources (DERs), use of new demand side management tools, and the prevalence of microgrids. In these situations, traditional point forecasting cannot adequately capture uncertainty, a task that is better accomplished by probabilistic load forecasting (PLF). PLF refers to predicting load in the form of intervals, density functions, or other probabilistic structures instead of a single point output. Compared to the point forecasting, probabilistic forecasting is a better alternative due to the fact that it can reveal more information on the uncertainty. As the point forecast is never perfect, probabilistic forecasting approaches in general are particularly appealing and comprehensive for the power system decision-making process as more and more uncertainties are involved in dynamic environments.

### SUMMARY OF THE INVENTION

In one aspect, systems and methods are disclosed to forecast electrical loads in an energy grid with a processor to receive load information from the energy grid.

In another aspect, a two-stage probabilistic load forecasting framework operates by integrating point forecast as a key probabilistic forecasting feature into the PLF. In the first stage, all predetermined features are utilized to train a point forecast model and obtain the feature importance. In the second stage the probabilistic forecasting model is trained, taking into consideration point forecast features, as well as selected feature subsets. During the testing period of the forecast model, the final probabilistic load forecast results are leveraged to obtain both point forecasting and probabilistic forecasting.

Advantages of the system may include one or more of the following. The system can be used for short-term load forecasting, which is a critical element of power systems energy management systems. The system provides improved PLF which provides uncertainty information that helps to improve the reliability and economics of system operation performances. For example, numerical results obtained from ISO New England demand data demonstrate the effectiveness of the instant approach in the hour-ahead load forecasting, which uses the gradient boosting regression for the point forecasting and quantile regression neural networks for the probabilistic forecasting. Moreover, the optimized learning structure achieves both improved forecasting accuracy and computation efficiency.

### BRIEF DESCRIPTIONS OF FIGURES

The features of the exemplary embodiments believed to be novel and the elements characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 shows an exemplary framework of a two-stage method.

FIG. 2 shows New Hampshire historical data from 2013-2017.

FIG. 3 illustrates New Hampshire Weather Impacts from 2013-2017.

FIG. 4 shows Pinball Loss and Winkler Score over ISO New England.

FIG. 5 illustrates a Direct QGBR Model for 72-hour Real Time DemandForecasting from 2017 Jun. 14 to 2017 Jun. 17.

FIG. 6 shows various exemplary Evaluation Metrics for NN structure.

FIG. 7 shows exemplary Model Comparison for Testing Evaluation Metrics.

FIG. 8 shows exemplary Important Features Selected in First stage.

### DETAILED DESCRIPTION

A two-stage probabilistic load forecasting framework is detailed next. The framework integrates point forecast as a key probabilistic forecasting feature into probabilistic load forecasting. In the first stage, point forecasting is conducted to provide the load forecast with additional features to enable second stage forecasting and to be able to select features based on feature importance. Then, the second stage combines the point forecast and selected features to efficiently generate the probabilistic forecast with desired quantile levels. A detailed case study based on ISO New England load data is used to demonstrate the effectiveness of the instant method in hour-ahead load forecasting. When compared with benchmark cases, the instant two-stage approach achieves lower forecast errors and narrower prediction intervals.

Traditional load forecasting minimizes the 12-norm to provide the conditional mean ŷₜ of target yₜ as shown in equation (1.1), and only a single output is given.

L(ŷₜ,yₜ)=∥ŷₜ−yₜ∥₂ (1.1)

Probabilistic forecasting, on the other hand, aims at estimating the probability distribution to fully reveal the future uncertainties. One of the most widely acknowledged probabilistic forecasting approaches is to compute a group of quantiles to discretize the density function for the targeted time interval. Quantile function represents the inverse of cumulative density function (CDF). Assuming Y is a real-valued random variable, the CDF F and the corresponding q-quantile are given in equations (1.2) and (1.3).

F_{Y}(y)=P(Y≤y) (1.2)

Q_{Y}(q)=F_{Y}⁻¹(q)=inf{y|F_{Y}(y)≥q} (1.3)

In probabilistic forecasting, pinball loss function is commonly adopted to evaluate the estimation performances as shown in (1.4), where ŷ_{t,q} is the estimated q-quantile output.

$${L}_{q} ( {\hat{y}}_{t , q} , {y}_{t} ) = \{ \begin{matrix}( 1 - q ) ( {\hat{y}}_{t , q} - {y}_{t} ) , & {\hat{y}}_{t , q} \geq {y}_{t} \\ q ( {y}_{t} - {\hat{y}}_{t , q} ) , & {\hat{y}}_{t , q} < {y}_{t}\end{matrix} \qquad ( 1.4 )$$

For the quantile regression problem, ŷ_{t,q} is represented with a linear form as in equation (1.5), where Xₜ and β_{q} are the feature vector and the estimated parameters for the quantile level-q, respectively.

ŷ_{t,q}=Xₜβ_{q} (1.5)

Similar to the linear quantile regression form as in (1.5), ŷ_{t,q} can be estimated with other forms as well to minimize the pinball loss. For example, quantile regression neural network (QRNN), quantile gradient boosting regression (QGBR) and quantile regression forests (QRF) are all applicable in this task.

Next, the two-stage PLF system is detailed. The input data for the instant two-stage approach include historical demand data, time-predetermined features, and weather-predetermined features. Time-predetermined features are generated with one-hot encoding to represent the binary indicators of the month of year, day of week, and hour of day. Weekdays and weekends are thus not differentiated. Regarding the weather-predetermined features, dry-bulb temperatures and dew point temperatures are collected from the weather stations. Dry-bulb temperature is actually the ambient air temperature, and relative humidity is measured by the degree of closeness between the dry bulb temperature and the dew point temperature. The historic air temperature and relative humidity are considered in the model training to account for the recency effect as suggested in [6]. Equation (1.6) computes this relative humidity, where Hₜ, Tₜ^{db}, T^{dp} represent the relative humidity, dry bulb temperature, and dew point temperature at time t, respectively. Higher values suggest a higher air humidity.

Hₜ=100−(Tₜ^{db}−Tₜ^{db}) (1.6)

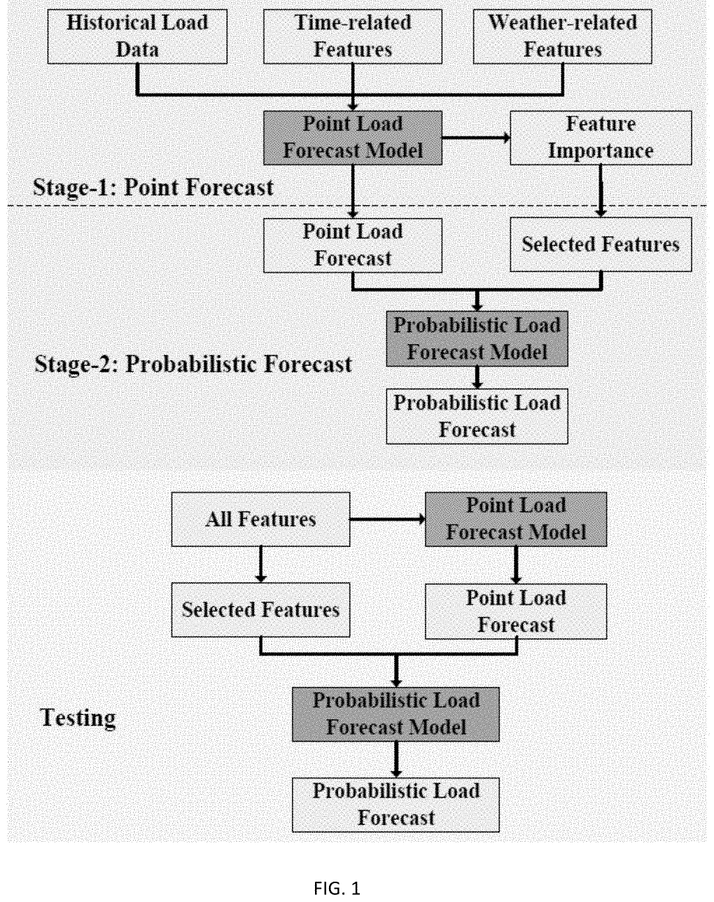

FIG. 1 presents the flowchart of the instant two-stage probabilistic load forecasting approach. The training process is split into two stages: first stage and second stage. In first stage, the input features are first used to train a point forecasting model, which provides the feature importance and point forecast outputs to second stage. The features are ranked according to the contributions to the forecasting results, which are the outputs from tree-based regression methods, such as gradient boosting regression (GBR). These selected high-impact features aim to reduce the second stage computing time by extracting necessary information to ensure solution quality. In second stage, these selected features as well as the produced point forecast are then fed into the probabilistic forecasting engine to train the model.

In the testing process, test data is first fitted into the trained first stage point forecasting model; then the output and the selected features from first stage are used by the trained second stage probabilistic forecasting model to generate final quantile predictions.

Various machine learning methods can be incorporated into first stage and second stage model training. For instance, random forests, gradient boosting regression (GBR) and deep neural networks (DNN) can be applied for the point forecasting model; QRF, QGBR, and QRNN are possible options for the probabilistic load forecasting model. Other machine learning techniques can also be applied as well. In this invention, GBR is selected for first stage, and QRNN is selected for second stage. For benchmark settings, a direct QGBR model and direct QRNN are trained over the whole training first stage and second stage to generate probabilistic load forecasting for testing.

Feature Selection will be discussed next. In the forecasting model, feature selection is a critical step to determine the machine learning model inputs. The goal is to identify the important feature candidates and to explore the best feature combinations that are adequate for revealing insightful knowledge with the least amount of information redundancy. Rather than directly feeding all features into the model, this feature selection step is also helpful to improve the model computational efficiency with reduced input dimensions.

In the instant two-stage PLF framework, all features, including historical load data, time and weather-predetermined features, are first used in the first stage point load forecasting model. GBR is applied in this stage for feature selection as it can produce the relative feature importance for all input features. With such a procedure, the most important features are identified through a list of features ranked by their relative importance rate. Then, the cumulative importance cut point is defined to determine which feature combination to adopt in second stage. In the meantime, the point load forecast given by first stage is also used as an additional input feature for the second stage. Via point forecast integration, a set of new feature combinations is constructed that significantly reduces the input dimension for the second stage model while retaining the most information.

Other feature selection methods, including lasso regression, ridge regression or forward selection, can also be applied. GBR provides a more interpretable way to combine due to its prediction process, which is why it is adopted in the approach presented in the instant system.

In point forecasting settings, common evaluation metrics, including root-mean-square error (RMSE), mean-absolute error (MAE), and mean-absolute-percentage error (MAPE), are applied to assess the prediction accuracy. However, these methods are not suitable for evaluating probabilistic forecasting. In this system, the main metric used is pinball loss as in equation (1.4), which provides a comprehensive evaluation. All of the interested quantile levels 0.05, 0.10, 0.15, . . . , 0.95 would be estimated. The average pinball loss across all the observations and quantile levels is then calculated as the final evaluation result.

Another probabilistic evaluation metric adopted in this system is Winkler Score, which is based on both the coverage and the width of prediction intervals. Defined as follow in (1.7), where δₜ, Lₜ, Uₜ, α are the width, the lower bound, the upper bound, and the confidence levels of prediction intervals, respectively.

$${WS}_{t} = \{ \begin{matrix}{δ}_{t} , & {U}_{t} \geq {y}_{t} \geq {L}_{t} \\ {δ}_{t} + 2 ( {L}_{t} - {y}_{t} ) / α , & {L}_{t} > {y}_{t} \\ {δ}_{t} + 2 ( {y}_{t} - {U}_{t} ) / α & {U}_{t} < {y}_{t}\end{matrix} \qquad ( 1.7 )$$

In addition, prediction interval coverage probability (PICP) is also computed to assess quantile predictions in (1.8) and (1.9), where cᵢ indicates whether the i-th actual load value yₜ is included in the interested α-level prediction interval, and N is the number of testing samples. Therefore, a PICP larger than α implies a reliable forecasting result.

$$\begin{matrix}{c}_{i} = \{ \begin{matrix}1 , & {y}_{i} ∈ {I}_{t}^{α} ( {x}_{i} ) \\ 0 , & {y}_{i} ∉ {I}_{t}^{α} ( {x}_{i} )\end{matrix} & ( 1.8 ) \\ PICP = \frac{1}{N} {\sum }_{i = 1}^{N} {c}_{i} & ( 1.9 )\end{matrix}$$

The instant predictive framework significantly improves the forecasting accuracy compared with direct quantile forecast. Numerical results from ISO New England load demonstrate the effectiveness of the instant method on hour-ahead probabilistic load forecasting. Moreover, a relative optimized NN structure of the second stage QRNN model achieves both the forecasting accuracy as well as the computation efficiency.

The system can be used for short-term load forecasting, which is a critical element of power systems energy management systems. The system provides improved probabilistic load forecasting (PLF) which provides uncertainty information that helps to improve the reliability and economics of system operation performances. As shown herein, the two-stage probabilistic load forecasting framework integrates point forecast as a key probabilistic forecasting feature into PLF. In the first stage, all predetermined features are utilized to train a point forecast model and also obtain the feature importance. In the second stage the forecasting model is trained, taking into consideration point forecast features, as well as selected feature subsets. During the testing period of the forecast model, the final probabilistic load forecast results are leveraged to obtain both point forecasting and probabilistic forecasting. Numerical results obtained from ISO New England demand data demonstrate the effectiveness of the instant approach in the hour-ahead load forecasting, which uses the gradient boosting regression for the point forecasting and quantile regression neural networks for the probabilistic forecasting.

Next, benchmarks are discussed with the two stage forecasting approach on load data from ISO New England public dataset, including eight sub-load zones (CT, ME, NH, RI, VT, SEMA, WCMA and NEMA) and the total system load. Hourly demand and weather information from 2013 Jan. 1 to 2017 Dec. 31 are collected. Particularly, the first three-year data is used for training and validation for first stage, and the fourth year is used for second stage. Testing stage is conducted with the last year data.

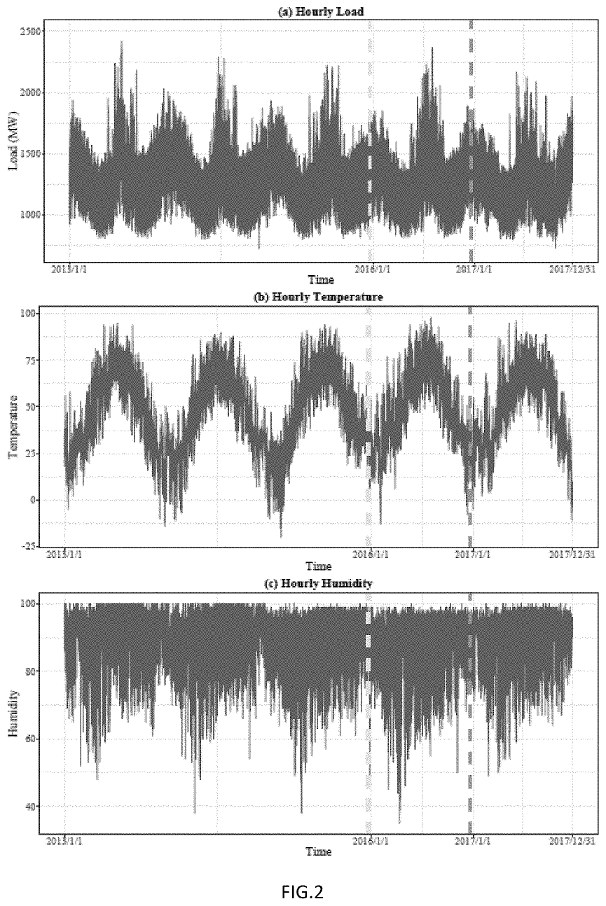

For illustration purpose, FIG. 2 presents the hourly demand, temperature (dry bulb) and relative humidity in the New Hampshire (NH) area. The yellow and the green dot line separate first stage, second stage, and the testing stage. Seasonal and periodic patterns are easily identified for the load and temperature.

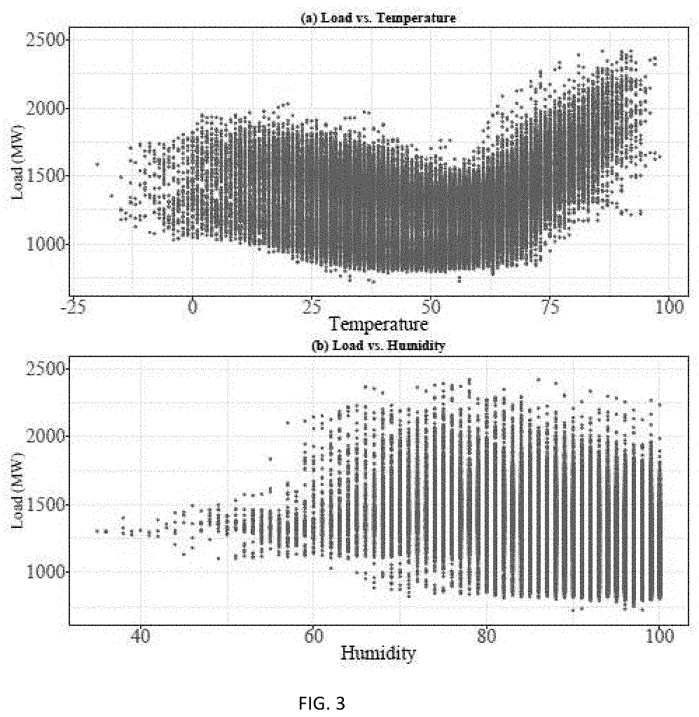

FIG. 3 shows the scatter plots for (a) demand versus temperature and (b) demand versus relative humidity in the New Hampshire area. In FIG. 3(a), the ‘V’ shape indicates a strong correlation between the demand and the temperature. Therefore, it is important to include such effect in the model. On the other hand, no clear relationship is identified between the demand and relative humidity, as shown in FIG. 3(b).

Hour-ahead forecasting is conducted with the instant two-stage PLF method on all eight load zones and the entire ISO-New England. Quantiles in 5%, . . . , 95% are predicted for the probabilistic forecasting. In addition, medians (50% quantile) are also provided for the final point measurement.

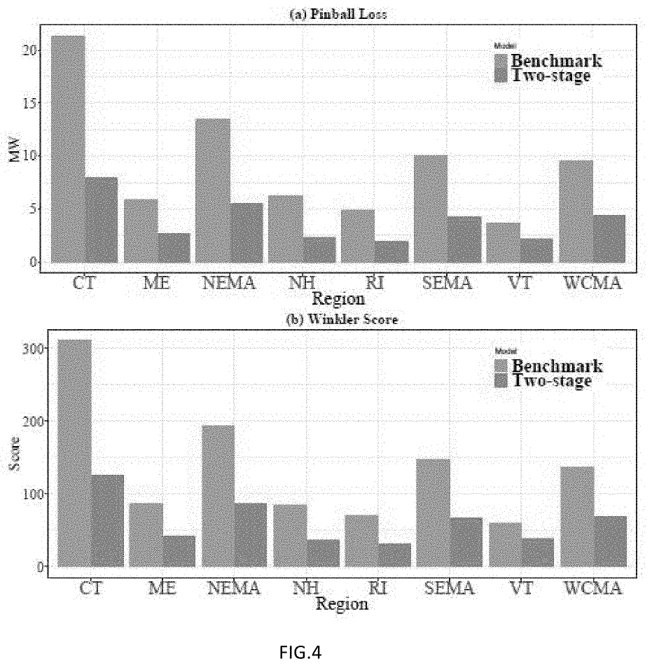

FIG. 4 presents the pinball loss and Winkler score over eight load zones. The instant two-stage method GBR+QRNN is compared with the benchmark method of direct QGBR. The instant method outperforms the benchmark in all areas to improve the forecasting accuracy. The New Hampshire load zone is selected for further illustrations.

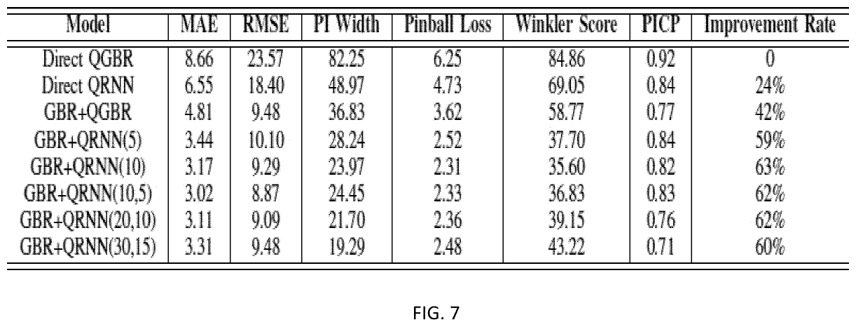

FIG. 7 presents the probabilistic load forecasting evaluation by MAE, RMSE, prediction interval width between 5% and 95% levels, averaged Pinball loss, averaged Winkler score, and PICP for direct models and two-stage models. For two-stage methods in second stage, different QRNN structures are also explored to further optimize its structure. Also, improvement rates are given based on pinball loss. From FIG. 7 and FIG. 4, the instant two-stage PLF framework achieves a huge improvement in quantile prediction accuracy. The reason is that integrating the point forecast in the feature greatly improves the probabilistic forecasting model capabilities by explicitly capturing the future load behaviors. In addition, it implicitly incorporates the raw features in first stage for point forecasting, which requires less features in the second stage for probabilistic forecasting. It clearly shows the simple yet effective effect with such point forecast integration.

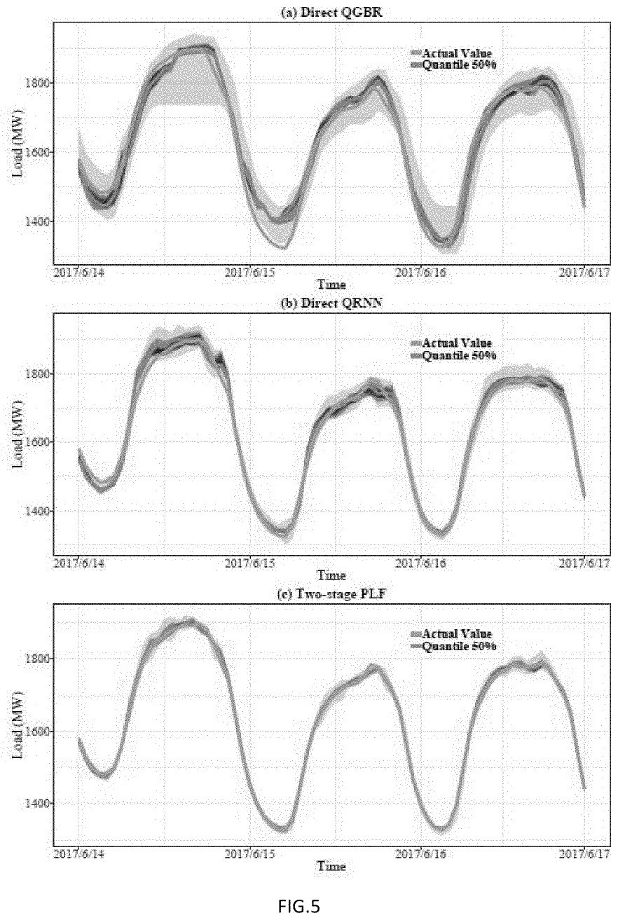

FIG. 5 shows a 72-hour probabilistic load forecast result in the New Hampshire area from 2017 Jun. 14 00:00 to 2017 Jun. 17 00:00 for (a) Direct QGBR, (b) Direct QRNN and (c) two-stage GBR+QRNN. Compared with the benchmark methods, a more narrower prediction interval is clearly demonstrated when using the instant two-stage method. In addition, the actual loads are almost always within the predicted ranges with the two-stage GBR+QGBR model, whereas there is an off-target period for the benchmark model around 2017 Jun. 15 00:00. Since this is an ISO-level hour-ahead forecasting, the uncertainty range should not be large or wide. The instant two-stage GBR+QGBR model meets such intuition and requirement. In the future work to extend from the hour-ahead to day-ahead forecasting, this prediction intervals are expected to be wider.

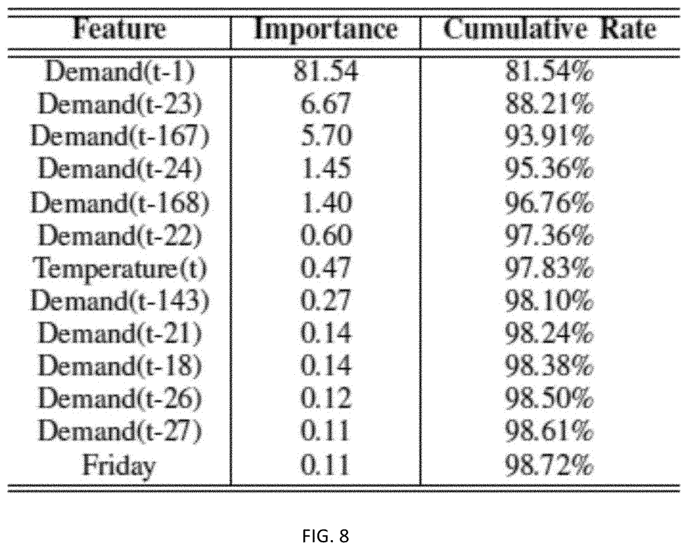

FIG. 8 shows the selected features from the first stage GBR model for ISO New England total load, ranked by their relative importance. The top-ranked features serve as input features for the second stage probabilistic forecasting model. As hour-ahead forecasting is the objective, it is not surprising to see the historical load for the past 1-day and past 7-days act as more important factors for the prediction.

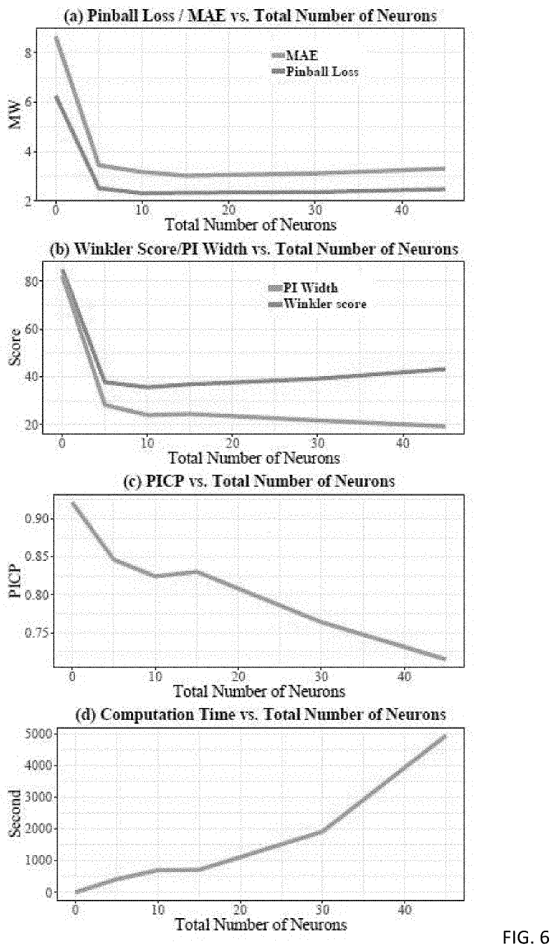

To further investigate the proper neural network structures in the second stage probabilistic forecasting, extensive simulations are carried out to explore how they affect forecasting performances as shown in FIG. 6. From these figures, the trends in all Pinball loss, Winkler-Score, and MAE imply that the probabilistic forecasting accuracy is improved to a certain point as the NN structure becomes more complex. The accuracy improvement is then merely marginal after the structure becomes too complex. This suggests a properly optimized structure is important for second stage QRNN to avoid overfitting. In this case, the lowest pinball loss and Winkler score are obtained simultaneously at a single-layer NN in 10 neurons while the lowest MAE and RMSE are obtained at a two-layer NN in neurons. Moreover, the decreasing trend of prediction interval width indicates the overfitting issues with complex NN, especially for this highly predictable hour-ahead load data. Another factor is the computational efficiency. FIG. 6(d) shows that the training time significantly increases when more neurons are used, however, with minimal accuracy improvement. Therefore, a single-layer with 10 neuron QRNN model is the appropriate NN structure in this problem to achieve the tradeoff between the accuracy and the computation speed. In addition, this NN structure choice also meets the Occam's razor principle to select simpler models when possible.

As detailed above, the two-stage probabilistic load forecasting method to integrate point forecast as key forecasting enablers. In the first stage, the point forecasting model provides the point load forecast as the core features in the second stage probabilistic forecasting model. In addition, historical load, time and weather-predetermined features are selected by their relative importance rate for the second stage. This predictive framework significantly improves the forecasting accuracy compared with direct quantile forecast. Numerical results from ISO New England load demonstrate the effectiveness of the instant method on hour-ahead probabilistic load forecasting. Moreover, a relative optimized NN structure of the second stage QRNN model achieves both the forecasting accuracy as well as the computation efficiency.

As will be appreciated by one skilled in the art, aspects of the exemplary embodiments may be embodied as a system, method, service method or computer program product. Accordingly, aspects of the exemplary embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the exemplary embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the exemplary embodiments may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the exemplary embodiments have been described above with reference to flowchart illustrations and/or block diagrams of methods, apparatus (systems) and computer program products according to the exemplary embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in the Figures illustrate the architecture, functionality, and operation of possible implementations of systems, methods, service methods and computer program products according to the exemplary embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A system to forecast electrical loads in an energy grid, comprising:
a processor to receive load information from the energy grid;
a two-stage probabilistic load forecasting unit with integrated point forecast as a probabilistic load forecasting (PLF), including:
a first stage where predetermined features are utilized to train a point forecast model and obtain one or more point forecast features; and
a second stage where the probabilistic forecasting model is trained, taking into consideration point forecast features.

2. The system of claim 1, wherein during the testing period of the forecast model, final probabilistic load forecast results are leveraged to obtain both point forecasting and probabilistic forecasting.

3. The system of claim 1, wherein the forecasting model is trained with selected feature subsets.

4. The system of claim 1, wherein the predetermined features are ranked according to the contributions to the forecasting results, which are the outputs from tree-based regression methods, such as gradient boosting regression (GBR).

5. The system of claim 1, wherein the predetermined features reduce the second stage computing time by extracting information to ensure solution quality.

6. The system of claim 1, wherein the predetermined features and produced point forecast are provided to the probabilistic forecasting engine to train the model in the second stage.

7. The system of claim 1, wherein during testing, test data is first fitted into the trained first stage point forecasting model; then the output and the selected features from the first stage are used by the trained second stage forecasting model to generate predictions.

8. The system of claim 1, wherein each stage comprises a learning machine to be trained.

9. The system of claim 1, wherein one of random forests, gradient boosting regression (GBR) and deep neural networks (DNN) is used for the point forecasting model, and one of QRF, QGBR, and QRNN is used for a probabilistic load forecasting model.

10. The system of claim 1, wherein GBR is selected for the first stage, and QRNN is used for the second stage.

11. The system of claim 1, wherein a direct QGBR model and direct QRNN are trained over training first and second stages to generate probabilistic load forecasting for testing.

12. The system of claim 1, wherein the predetermined features include historical load data, time, and weather-predetermined features.

13. The system of claim 1, wherein the predetermined features are used in a first stage point load forecasting model.

14. The system of claim 1, wherein predetermined features are identified through a list of features ranked by a relative importance rate, and a cumulative importance cut point is defined to determine a feature combination for the second stage.

15. The system of claim 1, wherein the point load forecast given by the first stage is used as an additional input feature for the second stage.

16. The system of claim 1, wherein the predetermined features comprise a set of feature combinations is constructed that reduces the input dimension for the second stage model while retaining the most information.

17. The system of claim 1, wherein the predetermined feature selection applies lasso regression, ridge regression or forward selection, and GBR.

18. A software to forecast loads in an energy grid, comprising:
computer readable code to provide a two-stage probabilistic load forecasting with integrated point forecast as a probabilistic load forecasting (PLF), including:
a first stage where predetermined features are utilized to train a point forecast model and obtain the feature importance; and
a second stage where the forecasting model is trained, taking into consideration point forecast features.

19. A method to forecast loads in an energy grid, comprising:
providing a two-stage probabilistic load forecasting unit with integrated point forecast as a probabilistic forecasting feature into probabilistic load forecasting (PLF), including:
training a point forecast model at a first stage where predetermined features are utilized and obtaining a set of point forecast features; and
training a forecasting model at a second stage, and taking into consideration point forecast features.
